(19) United States
(12) Patent Application Publication
(10) Pub. No.: US 2009/0208055 A1
(43) Pub. Date: Aug. 20, 2009

(54) Efficient detection of broken line segments in a scanned image

(75) Inventors: Edward K. Chin, Endicott, NY (US); Bingcheng Li, Vestal, NY (US); Stephen R. Shafer, Vestal, NY (US)

Correspondence Address: TAROLLI, SUNDHEIM, COVELL & TUMMINO LLP, Suite 1700, 1300 East Ninth Street, CLEVELAND, OH, 44114, US

(73) Assignee: Lockheed Martin Corporation

(21) Appl. No.: 12/070,611

(22) Filed: Feb. 20, 2008

(51) Int. Cl. G06K 9/00

(52) U.S. Cl. 382/103

(57) ABSTRACT

Systems and methods are presented for detecting and repairing broken lines within an image from a plurality of edge segments comprising a plurality of pixels and having associated first and second endpoints. A characteristic angle is determined for each edge segment. A normal distance is determined for each line segment according the distance of closest approach to a reference point for a line defined by the first and second endpoints of each edge segment. At least one line within the scanned image is located according to the determined characteristic angles and the determined normal distance for the plurality of edge segments.

### FIELD OF THE INVENTION

The present invention is directed generally to image processing systems and is particularly directed to the efficient detection of broken line segments within a scanned image.

### BACKGROUND OF THE INVENTION

In some applications, a limited amount of time is available to make a decision about any one envelope that is input into the mail stream. For example, postal indicia, that is any non-address data on an envelope or package, must be scanned, located, and recognized in a period on the order of one hundred milliseconds to maintain the flow of mail through the system. These time constraints limit the available solutions for accurately classifying and verifying postal indicia on an envelope.

In order for recognition of any postal indicia on the envelope to occur, it is necessary to locate regions of interest on the envelope. One method for locating regions of interest includes locating long, unbroken lines within the envelope that might indicate such items as mailing labels, address envelopes, stamps, and similar regions likely to contain indicia of interest. Unfortunately, deficiencies in conventional line detection algorithms make it difficult to reliably detect these regions in the limited time available for region detection.

### SUMMARY OF THE INVENTION

In accordance with one aspect of the present invention, a method is provided for detecting and repairing broken lines within an image from a plurality of edge segments comprising a plurality of pixels and having associated first and second endpoints. A characteristic angle is determined for each edge segment. A normal distance is determined for each line segment according the distance of closest approach to a reference point for a line defined by the first and second endpoints of each edge segment. At least one line within the scanned image is located according to the determined characteristic angles and the determined normal distance for the plurality of edge segments.

In accordance with another aspect of the present invention, a system is provided for detecting broken lines within a scanned image. An edge detection element identifies a plurality of edge segments within the scanned image. Each edge segment includes a plurality of pixels and has associated first and second endpoints. A segment characterization element determines a characteristic angle for each edge segment and a normal distance for each edge segment equal to a distance of closest approach to a reference point by a line defined by the first and second endpoints of the edge segment. An image analysis element determines a characteristic angle and a distance of closest approach to the reference point for at least one line within the scanned image from the determined characteristic angles and normal distances. A segment merger connects at least two edge segments having normal distances and characteristic angles associated with a line within the scanned image.

In accordance with yet another aspect of the present invention, a computer readable medium is provided for detecting and repairing broken lines within a scanned image. An edge detection element identifies a plurality of edge segments within the scanned image. Each edge segment includes a plurality of pixels and has associated first and second endpoints. A theta determination element determines a theta value for each edge segment as the angle between a line defined by the first and second endpoints of the edge segment and a reference axis. A rho determination element determines a rho value as the length of a line segment running normal to the defined line, beginning at a reference point, and terminating on the line defined by the first and second endpoints of the edge segment. An image histogram records the determined rho and theta value for each edge segment by adding a value equal to the length of the edge segment in pixels to a histogram bin associated with the determined rho and theta values. A line analysis element determines characteristic rho and theta values for at least one line within the scanned image from the image histogram. A segment merger connects at least two edge segments having characteristic rho and theta values equal to that determined for a line within the scanned image.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 illustrates a system that locates broken line segments in an image in accordance with an aspect of the present invention;

FIG. 2 illustrates an exemplary implementation of an image correction system in accordance with an aspect of the present invention;

FIG. 3 illustrates a simplified representation of an exemplary system for identifying postal indicia on an envelope in accordance with an aspect of the present invention;

FIG. 4 illustrates a methodology for detecting and connecting a plurality of edge segments representing broken portions of line segments within an image of interest; and

FIG. 5 illustrates a computer system that can be employed to implement systems and methods described herein.

### DETAILED DESCRIPTION OF THE INVENTION

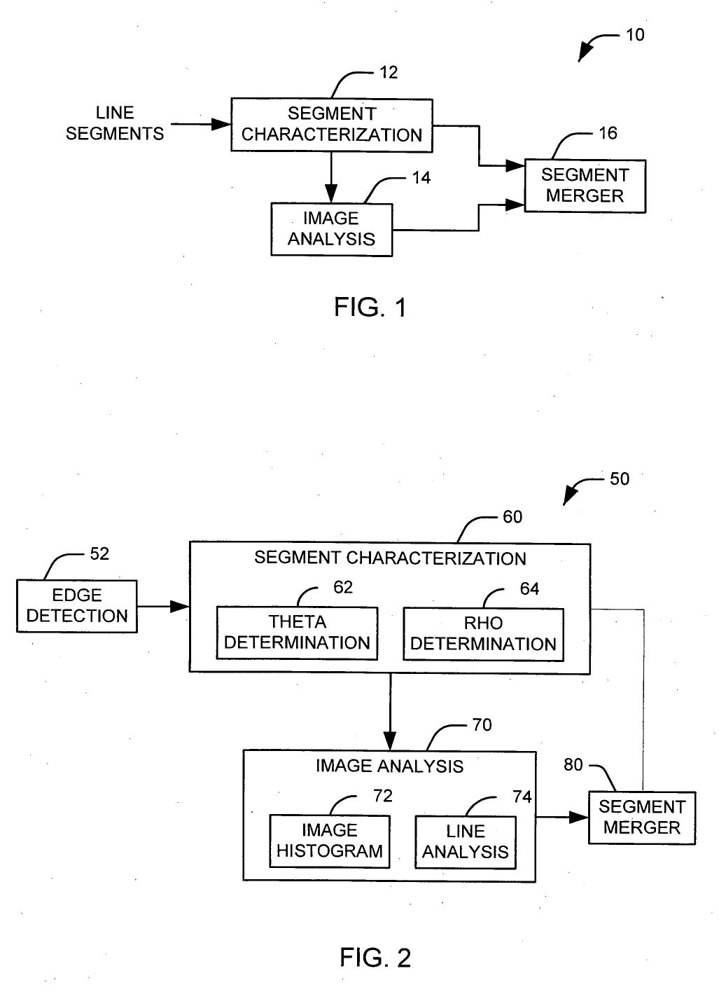

The present invention relates to systems and methods for the correction of digital images. FIG. 1 illustrates a system 10 that locates broken line segments in an image in accordance with an aspect of the present invention. It will be appreciated that the system of FIG. 1 can be implemented as dedicated hardware, a software program stored on a computer readable medium and operative on in a general purpose computer, or as some combination of hardware and software components.

A plurality of edge segments representing broken portions of line segments within an image of interest are provided to a segment characterization element 12. It will be appreciated that the edge segments can be produced via any of a number of appropriate edge detection or binarization algorithms, such that the endpoints of the plurality of edge segments can be known with regards to an arbitrarily defined coordinate system.

The segment characterization element 12 determines two characteristic values for each edge segment. A representative angle, referred to herein as theta, of the edge segment can be determined for the edge segment with respect to an appropriate reference, such as a horizontal axis in a rectangular coordinate system or particular value (e.g., 0) along the angular axis in a polar coordinate system.

A distance of closest approach to a reference point, for example, the origin, for a line represented by the edge segment, referred to herein interchangeably as a rho value or normal distance for the edge segment, can be determined as the length of a line segment running normal to the represented line and having endpoints at the reference point and on the represented line. By the line represented by the edge segment, it is meant the line defined by the two endpoints and continuing on to infinity in both directions. It will be appreciated that the represented line and the normal edge segment are theoretical constructs used solely for illustration, and that systems and methods in accordance with an aspect of the present invention can be utilized for determining rho without directly referencing either.

The determined rho and theta values as well as the number of pixels in each edge segment are provided to an image analysis component 14. The image analysis component 14 determines rho and theta values representing one or more lines within the image according to the rho and theta values associated with the edge segments. For example, the image analysis component 14 can comprise a two-dimensional histogram representing discrete ranges of rho and theta. Each edge segment contributes a value equal to its length to a histogram bin representing the ranges in which its associated rho and theta values fall. When each edge segment has been evaluated, the bins having the largest values indicate the position of lines within the image.

Once at least one line has been located within the image according to its rho and theta values, broken lines within the image can be reconstructed at a segment merger 16. The segment merger 16 associates groups of one or more edge segments with the one or more lines according to the associated rho and theta values for the edge segments. Once each line has an associated group of edge segments, line segments along that line can be reconstructed (e.g., by filling gaps between edge segments) from the known endpoints of the edge segments and a series of logical rules. It will be appreciated that these logical rules will vary with the type of image and the application to which the system 10 is being applied.

In one implementation, the extreme endpoints along the lines, that is, the pair of endpoints separated by the greatest distance, can be considered to be the endpoints of an original scanned line segment. Alternatively, edge segments that are within a threshold distance of one another can be connected. It will be appreciated, however, that more complex implementations are possible. For example, the logical rules can include imposing minimum and maximum lengths for line segments, treating edge segments separated by a gap larger than a threshold value as separate line segments, and varying associated threshold values and length ranges according to characteristics of the image or specific portions of the image.

FIG. 2 illustrates an exemplary implementation of an image correction system 50 in accordance with an aspect of the present invention. The illustrated implementation 50 is designed for use in region of interest extraction in a mail sorting system. For example, straight line segments of significant size can be found on the edges of response windows, mailing labels, and meter marks within the image, all regions in which information of interest for mail processing can be located. Such systems must locate, extract and analyze one or more regions of interest on each mail piece accurately under significant time constraints, and the system 50 is designed to efficiently locate broken segments and correct them to facilitate the subsequent location of regions of interest.

A scanned image is received at an edge detection component 52. The edge detection component 52 reviews the scanned image for edges within the image, and produces a plurality of edge segments representing the scanned image. Edges, as used herein, represent sharp changes in image characteristics between spatially proximate pixels. In other words, a detected edge represents a change in the value of a chromatic characteristic of an image, such as hue, brightness (e.g., grayscale intensity), and saturation over a certain number of pixels that exceeds a threshold. A number of edge detection algorithms are known in the art and suitable for use in the illustrated system, including methodologies using each of the Roberts Cross algorithm, Prewitt, Sobel, Canny, and Marr-Hildreth operators. In the illustrated example, due to the time constraints on the application of interest, an edge detection process will be selected that emphasizes speed at the expense of accuracy, as measured in the number of broken lines produced.

The edge segments produced by the edge detector are provided to a segment characterization component 60 that determines a characteristic angle and normal distance for each edge segment. The segment characterization component 60 includes a theta determination component 62 that determines a characteristic angle for each line segment. Specifically, the theta determination component 62 determines the angle between the line segment and a reference line. In the illustrated example, the reference line is a horizontal line (e.g., θ=0). It will be appreciated that a characteristic angle for each edge segment can be determined by any appropriate means from the known endpoints of the edge segments, for example, by finding the arctangent of a calculated slope of the edge segment.

The segment characterization component 60 further comprises a rho determination component 64 that determines a normal distance, rho, for the edge segment, reflecting the closest approach to a reference point by a line defined by the endpoints of the edge segment. It will be appreciated that the normal distance does not necessarily relate to the distance of either endpoint or any other point within the edge segment to the reference point, but rather the closest approach of a line, reflecting a theoretical extension of the edge segment to infinite length in both directions, to the reference point. The term “normal distance” is used to describe this distance of closest approach, as the closest approach of the line to the reference point can be determined as the length of a line segment that runs normal to the line, with one endpoint at the reference point and a second endpoint on the line. An appropriate value for rho can be determined by any appropriate method based on the known endpoints and characteristic angle of the edge segment. In one implementation, the reference point is the origin.

Once appropriate rho and theta values have been determined for each edge segment, the rho and theta values can be provided to an image analysis component 70. The image analysis component 70 comprises an image histogram 72 that records rho and theta values for each edge segment as a two-dimensional histogram. Each of a plurality of bins comprising the histogram represents a discrete range of rho and theta values. For each edge segment having rho and theta values falling within the rho and theta ranges associated with the bin, a value equal to the length of the edge segment in pixels is added to the histogram bin. This is continued until all of the edge segments have contributed to the histogram.

A line analysis component 74 reviews the histogram to determine the location of one or more line segments within the image. For example, a rule-based analysis can be applied to the histogram data to select rho and theta values for one or more potential lines within the image. In one implementation, this is accomplished by a thresholding process that selects a histogram bin and its associated rho and theta values when the value associated with the bin exceeds a threshold value. It will be appreciated, however, that more complex processes can be utilized to select appropriate rho and theta values, including a normalization step that normalizes the histogram value to a predetermined constant or a dynamic thresholding process that varies the threshold according to one or more properties of the scanned image.

Once the line analysis component 74 identifies one or more lines within the image, a segment merger 80 connects sets of edge segments having rho and theta values associated groups of one or more edge segments with the at least one line according to the associated rho and theta values for the edge segments. It will be appreciated that the process of merging the edge segments will vary with the type of image and the application.

In one implementation, the extreme endpoints of edge segments falling along a given line can be determined and gaps below a threshold length between the determined endpoints can be filled. Alternatively, a set of logical rules can be utilized to fill in the gaps, including the imposition of minimum and maximum lengths for line segments, the treatment of edge segments separated by a gap larger than a threshold value as separate line segments, and the variance of associated threshold values and length ranges according to characteristics of the image or specific portions of the image.

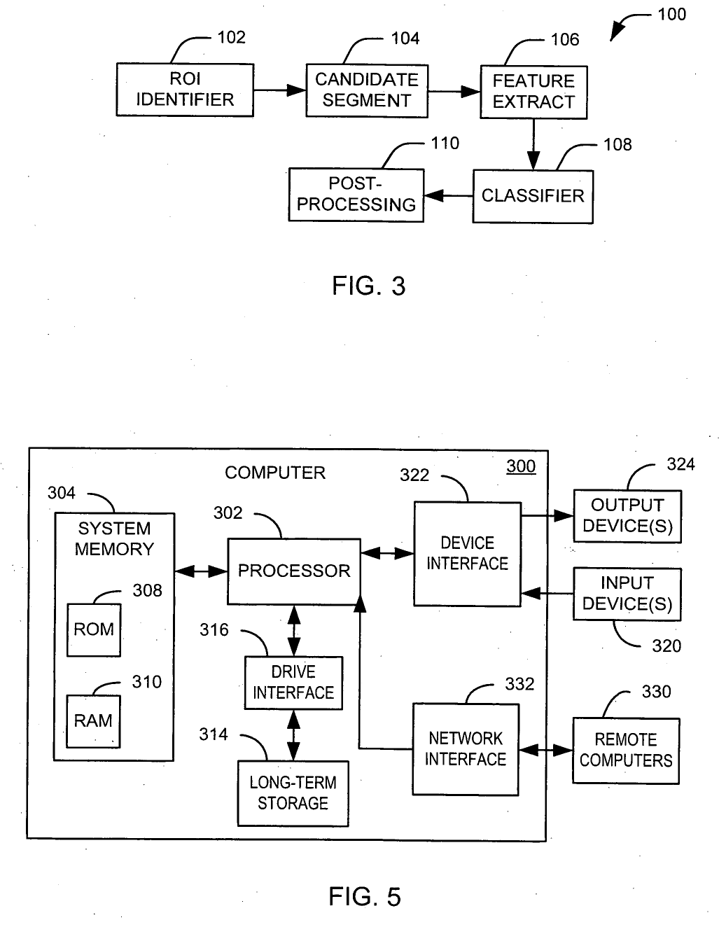

FIG. 3 illustrates a simplified representation of a system 100 for identifying postal indicia on an envelope in accordance with an aspect of the present invention. It will be appreciated that the time available to process a given envelope, including detection of at least the zip code and postage (e.g., metermark, stamp, etc.) on the envelope, must be accomplished within approximately one hundred milliseconds. To this end, the illustrated system 100 can utilize systems and methods in accordance with an aspect of the present invention to detect one or more regions of interest of an envelope image within a few milliseconds. It is necessary that the regions of interest be located with great efficiency to retain time and processing resources for the downstream analysis of the envelope.

A scanned image is received at a region of interest (ROI) identifier 102 that determines the location of one or more regions of interest within an image of an envelope. It will be appreciated that many regions of an envelope containing useful data tend to have long, unbroken edges, such as address windows, edges of stamps or address labels, and the boxes found in metermarks. In accordance with an aspect of the present invention, one or more regions of interest can be identified by running an edge detection algorithm and then detecting and repairing broken lines in; accordance with an aspect of the present invention. It will be appreciated that other methods of finding regions of interest (e.g., scanning for regions of high dark pixel density) can be utilized in concert with this methodology.

Each region of interest is reviewed to locate one or more candidate objects within the region of interest at a segmentation portion 104. At the segmentation portion 104, candidate objects, such as text characters and indicia relating to postage, are detected and isolated within the regions of interest. Each candidate object is provided to a feature extractor 106, where numerical feature values are extracted from the candidate objects as a feature vector. Each feature represents a quantifiable characteristic that is helpful in distinguishing a candidate object from other indicia. It will be appreciated that the feature extractor 106 can comprise a plurality of feature extraction processes associated with various types of postal indicia, such that the feature data extracted from each candidate object can be selected for maximum discriminant value.

The candidate objects are then classified into one of a plurality of output classes according to the extracted feature vectors at a classification element 108. It will be appreciated that the classification element 108 can comprise a plurality of pattern recognition classifiers, each useful for distinguishing among different types of indicia. The classification element 108 can utilize one or more of neural networks, support vector machines, statistical classifiers, and similar classifiers in sorting the candidate objects into appropriate output classes. The output class determined for each candidate object can then be provided to a post-processing element 110 that directs the processing of the envelope according to the determined output classes. For example, envelopes can be sorted according to their destination zip codes or rejected if the determined postage is found to be insufficient.

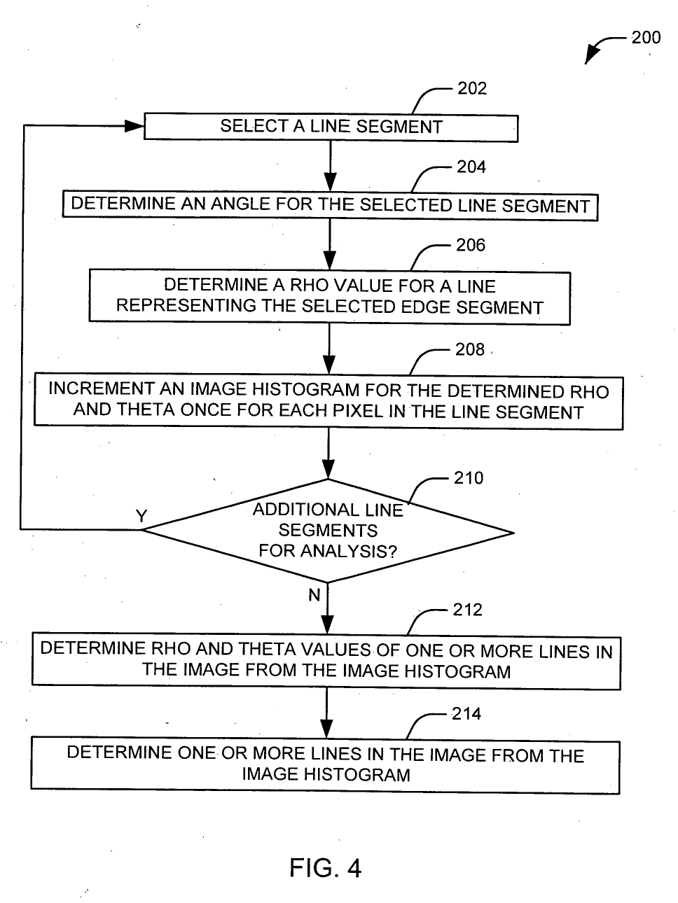

In view of the foregoing structural and functional features described above, methodologies in accordance with various aspects of the present invention will be better appreciated with reference to FIG. 4. While, for purposes of simplicity of explanation, the methodology of FIG. 4 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 4 illustrates a methodology 200 for detecting and connecting a plurality of edge segments representing broken portions of line segments within an image of interest. At step 202, a line segment is selected. At step 204, a characteristic angle is determined for the selected edge segment with respect to an appropriate reference. In the illustrated methodology, the reference is a horizontal axis in a coordinate system. Determination of the characteristic angle can be accomplished by any appropriate means, including calculating a slope for the line segment and finding the arctangent of the calculated slope.

A distance of closest approach to a reference point for a line represented by the selected edge segment, referred to herein interchangeably as a rho value or normal distance for the edge segment, can be determined at step 206. The normal distance can be determined as the length of a line segment running normal to the represented line and having endpoints at the reference point and on the represented line. Since the characteristic angle of the line segment is known, and thus the angle of the normal line segment with the reference axis is known, a value for rho can be determined by straightforward trigonometric calculation.

At step 208, a value equal to the length in pixels of the selected edge segment is added to the value contained in a histogram bin representing the ranges in which its associated rho and theta values fall. It is then determined at step 210 if additional edge segments remain for analysis. If so (Y), the process returns to step 202 to select another line segment.

If no line segments remain for analysis, rho and theta values for one or more lines within the scanned image can be determined at step 212. For example, one or more bins having the largest values can be selected, with the associated rho and theta values of the selected bins indicating the position of lines within the image. Alternatively, all bins having a value greater than a threshold can be selected.

Once at least one line has been located within the image according to its rho and theta values, broken lines within the image can be reconstructed at step 214. Groups of one or more edge segments having associated rho and theta values equal to that of the line can be connected (e.g., by filling gaps between edge segments) according to a series of logical rules. It will be appreciated that these logical rules will vary with the type of image and the application to which the methodology is being applied.

FIG. 5 illustrates a computer system 300 that can be employed to implement systems and methods described herein, such as based on computer executable instructions running on the computer system. The computer system 300 can be implemented on one or more general purpose networked computer systems, embedded computer systems, routers, switches, server devices, client devices, various intermediate devices/nodes and/or stand alone computer systems. Additionally, the computer system 300 can be implemented as part of the computer-aided engineering (CAE) tool running computer executable instructions to perform a method as described herein.

The computer system 300 includes a processor 302 and a system memory 304. Dual microprocessors and other multi-processor architectures can also be utilized as the processor 302. The processor 302 and system memory 304 can be coupled by any of several types of bus structures, including a memory bus or memory controller, a peripheral bus, and a local bus using any of a variety of bus architectures. The system memory 304 includes read only memory (ROM) 308 and random access memory (RAM) 310. A basic input/output system (BIOS) can reside in the ROM 308, generally containing the basic routines that help to transfer information between elements within the computer system 300, such as a reset or power-up.

The computer system 300 can include one or more types of long-term data storage 314, including a hard disk drive, a magnetic disk drive, (e.g., to read from or write to a removable disk), and an optical disk drive, (e.g., for reading a CD-ROM or DVD disk or to read from or write to other optical media). The long-term data storage can be connected to the processor 302 by a drive interface 316. The long-term storage components 314 provide nonvolatile storage of data, data structures, and computer-executable instructions for the computer system 300. A number of program modules may also be stored in one or more of the drives as well as in the RAM 310, including an operating system, one or more application programs, other program modules, and program data.

A user may enter commands and information into the computer system 300 through one or more input devices 320, such as a keyboard or a pointing device (e.g., a mouse). These and other input devices are often connected to the processor 302 through a device interface 322. For example, the input devices can be connected to the system bus 306 by one or more a parallel port, a serial port or a universal serial bus (USB). One or more output device(s) 324, such as a visual display device or printer, can also be connected to the processor 302 via the device interface 322.

The computer system 300 may operate in a networked environment using logical connections (e.g., a local area network (LAN) or wide area network (WAN) to one or more remote computers 330. The remote computer 330 may be a workstation, a computer system, a router, a peer device or other common network node, and typically includes many or all of the elements described relative to the computer system 300. The computer system 300 can communicate with the remote computers 330 via a network interface 332, such as a wired or wireless network interface card or modem. In a networked environment, application programs and program data depicted relative to the computer system 300, or portions thereof, may be stored in memory associated with the remote computers 330.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim the following:

1. A method for detecting and repairing broken lines within an image from a plurality of edge segments comprising a plurality of pixels and having associated first and second endpoints, comprising:
determining a characteristic angle for each edge segment;
determining a normal distance for each line segment according the distance of closest approach to a reference point for a line defined by the first and second endpoints of each edge segment; and
locating at least one line within the scanned image according to the determined characteristic angles and the determined normal distance for the plurality of edge segments.

2. The method of claim 1, further comprising connecting at least two edge segments having normal distances and characteristic angles associated with a line located within the scanned image.

3. The method of claim 2, wherein connecting at least two edge segments comprises:
determining two endpoints among the respective first and second endpoints associated with the at least two edge segments that are separated by the greatest distance; and
filling in gaps between the determined two endpoints.

4. The method of claim 2, wherein connecting at least two edge segments comprises connecting each pair of the at least two edge segments that are within a threshold distance of one another.

5. The method of claim 1, further comprising applying an edge detection algorithm to a scanned image to produce the plurality of edge segments.

6. The method of claim 1, wherein determining a characteristic angle for each edge segment comprises:
determining a slope of the edge segment; and
calculating an arctangent of the determined slope.

7. The method of claim 1, wherein locating at least one line within the scanned image comprises:
recording the determined characteristic angle and normal distance for each edge segment by adding a value equal to the length of the edge segment in pixels to a histogram bin associated with the determined characteristic angle and normal distance; and
determining an associated characteristic angle and normal distance for at least one line within the scanned image from the image histogram.

8. The method of claim 1, wherein the image is a scanned image from one side of an envelope.

9. A system for detecting broken lines within a scanned image, comprising:
an edge detection element that identifies a plurality of edge segments, each edge segment comprising a plurality of pixels and having associated first and second endpoints, in the scanned image;
a segment characterization element that determines a characteristic angle for each edge segment and a normal distance for each edge segment equal to a distance of closest approach to a reference point by a line defined by the first and second endpoints of the edge segment; and
an image analysis element that determines a characteristic angle and a distance of closest approach to the reference point for at least one line within the scanned image from the determined characteristic angles and normal distances; and
a segment merger that connects at least two edge segments having normal distances and characteristic angles associated with a line within the scanned image.

10. The system of claim 9, wherein the segment merger is operative to determine two endpoints among the respective first and second endpoints associated with the at least two edge segments that are separated by the greatest distance and fill in gaps between the determined two endpoints.

11. The system of claim 9, wherein the segment merger is operative to connect each pair of the at least two edge segments that are within a threshold distance of one another.

12. The system of claim 9, the image analysis element comprising an image histogram that records the determined characteristic angle and normal distance for each edge segment by adding a value equal to the length of the edge segment in pixels to a histogram bin associated with the determined characteristic angle and normal distance.

13. A mail processing system, comprising:
a region of interest identifier, comprising the system of claim 9, that locates regions of interest within the scanned image;
a segmentation component that isolates candidate objects within the located regions of interest;
a classification component that classifies the isolated candidate objects into respective output classes; and
a post-processing component that directs the processing of an envelope associated with the scanned image according to the classified candidate objects.

14. A computer readable medium that comprises computer executable instructions for detecting and repairing broken lines within a scanned image, comprising:
an edge detection element that identifies a plurality of edge segments, each edge segment comprising a plurality of pixels and having associated first and second endpoints, in the scanned image;
a theta determination element that determines a theta value for each edge segment as the angle between a line defined by the first and second endpoints of the edge segment and a reference axis;
a rho determination element that determines a rho value as the length of a line segment running normal to the defined line, beginning at a reference point, and terminating on the line defined by the first and second endpoints of the edge segment;
an image histogram that records the determined rho and theta value for each edge segment by adding a value equal to the length of the edge segment in pixels to a histogram bin associated with the determined rho and theta values;
a line analysis element that determines characteristic rho and theta values for at least one line within the scanned image from the image histogram; and
a segment merger that connects at least two edge segments having characteristic rho and theta values equal to that determined for a line within the scanned image.

15. The computer readable medium of claim 14, wherein the segment merger is operative to determine two endpoints among the respective first and second endpoints associated with the at least two edge segments that are separated by the greatest distance and fill in gaps between the determined two endpoints.

16. The computer readable medium of claim 14, wherein the segment merger is operative to connect each pair of the at least two edge segments that are within a threshold distance of one another.
